(19) United States
(12) Patent Application Publication
(10) Pub. No.: US 2022/0284332 A1
(43) Pub. Date: Sep. 8, 2022

(54) ANOMALY DETECTION APPARATUS, ANOMALY DETECTION METHOD AND PROGRAM

(71) Applicant: Nippon Telegraph and Telephone Corporation, Tokyo (JP)

(72) Inventors: Yuka HASHIMOTO, Musashino-shi, Tokyo (JP); Yoichi Matsuo, Musashino-shi, Tokyo (JP); Isao ISHIKAWA, Saitama (JP); Masahiro Ikeda, Saitama (JP); Yoshinobu KAWAHARA, Saitama (JP)

(21) Appl. No.: 17/636,635

(22) PCT Filed: Aug. 19, 2020
(86) PCT No.: PCT/JP2020/031316

§ 371 Date: Feb. 18, 2022

(30) Foreign Application Priority Data
Aug. 26, 2019 (JP) 2019-154065

(51) Int. Cl. G06N 7/00; G06F 17/17

(52) U.S. Cl. CPC G06N 7/005; G06F 17/17

(57) ABSTRACT

An anomaly detection apparatus includes an approximation unit configured to generate, based on observed data, an approximation of a Perron-Frobenius operator on an RKHS that represents a mathematical model to generate the observed data; and a detection unit configured to use the approximation of the Perron-Frobenius operator and an observed data item at time t, to predict a data item at time t+1, and based on a discrepancy between the predicted data item and an observed data item at time t+1, to determine whether the observed data item at time t+1 is anomalous.

### TECHNICAL FIELD

The present invention relates to analytical techniques for time-series data.

### BACKGROUND ART

As time-series data that includes random noise, there are data items including communication traffic, stock prices, weather data, and the like, and by approximating the behaviors of these data items, analytical techniques for feature understanding, prediction, anomaly detection, and the like are being investigated.

These methods can be classified into two broad categories. The first category includes methods using neural networks, and the second category includes methods in which time-series data is considered to be generated based on mathematical models. As for the second category, although classical methods assume a linear relationship among data items, in recent years, techniques for analyzing time-series data that use a mathematical instrument called the transfer operator, with which a model can be represented even for a nonlinear relationship, have been studied (Non-Patent Documents 1-3).

Non-patent document 1 discloses a technique for understanding a feature of time-series data having randomness by approximating eigenvalues and eigenfunctions of a transfer operator. Non-patent document 3 discloses a technique for calculating similarity between time-series data items not having randomness by using a transfer operator defined on a space called a reproducing kernel Hilbert space (RKHS). Non-patent document 2 discloses a technique for understanding a feature of time-series data having randomness by approximating eigenvalues and eigenfunctions of the transfer operator defined on an RKHS.

### RELATED ART DOCUMENTS

### Non-patent documents

[Non-patent document 1] Crnjaric-Zic, N., Macesic, S., and Mezic, I., Koopman Operator Spectrum for Random Dynamical Systems, arXiv:1711.03146, 2019

[Non-patent document 2] Klus, S., Schuster, I., and Muandet, K., Eigendecompositions of Transfer Operators in Reproducing kernel Hilbert spaces, arXiv:1712.01572, 2017

[Non-patent document 3] Ishikawa, I., Fujii, K., Ikeda, M., Hashimoto, Y., and Kawahara, Y., Metric on Nonlinear Dynamical Systems with Perron-Frobenius Operators, In Advances in Neural Information Processing Systems 31, p.p. 2856-2866, Curran Associates, Inc., 2018

### SUMMARY OF INVENTION

### Problem to be Solved by the Invention

The neural network is a method of approximating a relationship among data items without assuming a model; therefore, it is difficult to incorporate information on randomness into the approximation.

By considering a mathematical model, it is expected that a relationship among data items can be approximated while taking the randomness into account. However, any classical method using a mathematical model assumes a linear relationship among data items; therefore, for data items that exhibit nonlinear behavior, the accuracy of analysis falls.

Therefore, techniques to represent and analyze models in which nonlinear behaviors are assumed, by using transfer operators, have been studied. Conventional techniques using a transfer operator are only effective in the case where the transfer operator has good properties such as “having only a discrete spectrum” or “being bounded”.

However, a transfer operator that represents a model generating time-series data in practice does not necessarily have these properties. Also, the conventional techniques aim at approximating eigenvalues of a transfer operator and at calculating the degree of similarity among time-series data items, but do not aim at anomaly detection.

The present invention has been made in view of the above, and has an object to provide techniques with which behaviors of time-series data items including random noise can be approximated, to execute anomaly detection.

### Means for Solving Problems

According to the disclosure techniques, an anomaly detection apparatus is provided that includes:
an approximation unit configured to generate, based on observed data, an approximation of a Perron-Frobenius operator on a reproducing kernel Hilbert space (RKHS) that represents a mathematical model to generate the observed data; and
a detection unit configured to use the approximation of the Perron-Frobenius operator and an observed data item at time t, to predict a data item at time t+1, and based on a discrepancy between the predicted data item and an observed data item at time t+1, to determine whether the observed data item at time t+1 is anomalous.

### Effects of the Invention

According to the disclosed techniques, techniques are provided, with which behavior of time-series data items including random noise can be approximated, to execute anomaly detection. The present techniques are also applicable when the transfer operator does not have properties such as “having only a discrete spectrum” or “being bounded”.

### BRIEF DESCRIPTION OF DRAWINGS

FIG. 1 is a diagram illustrating a configuration of a time-series data anomaly detection apparatus;

FIG. 2 is a diagram illustrating an example of a hardware configuration of a time-series data anomaly detection apparatus;

FIG. 3 is a flow chart illustrating steps of approximation;

FIG. 4 is a flow chart illustrating steps of anomaly detection;

FIG. 5 is a flow chart illustrating steps of approximation and anomaly detection;

FIG. 6 is a diagram illustrating evaluation results of dispersion of predictions;

FIG. 7 is a diagram illustrating data used in evaluations;

FIG. 8 is a diagram illustrating data used in evaluations;

FIG. 9 is a diagram illustrating calculation results of the anomaly level;

FIG. 10 is a diagram illustrating calculation results of the anomaly level; and

FIG. 11 is a diagram illustrating calculation results of the anomaly level.

### MODE FOR CARRYING OUT THE INVENTION

In the following, embodiments of the present invention (the present embodiments) will be described with reference to the drawings. The embodiments described below are merely examples, and the embodiments to which the present invention is applied are not limited to the following embodiments.

### (System Configuration)

In the present embodiment, a method of approximating a transfer operator called a Perron-Frobenius operator on an RKHS, and as an application example of using it, a time-series data anomaly detection apparatus, i.e., a system that implements anomaly detection will be described. The present time-series data anomaly detection apparatus can also be applied to cases where the transfer operator does not have properties such as “having only a discrete spectrum” or “being bounded”.

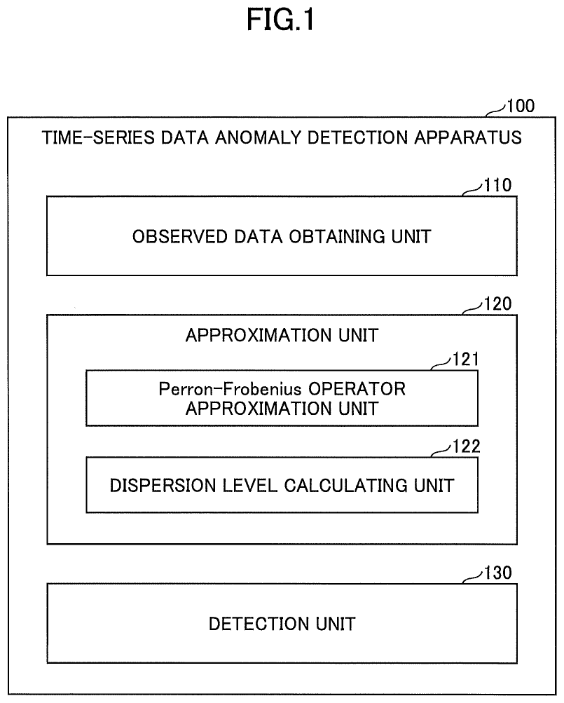

FIG. 1 illustrates a configuration diagram of a time-series data anomaly detection apparatus 100 in the present embodiment. As illustrated in FIG. 1, the time-series data anomaly detection apparatus 100 includes an observed data obtaining unit 110, an approximation unit 120, and a detection unit 130. The approximation unit 120 includes a Perron-Frobenius operator approximation unit 121 and a dispersion level calculating unit 122. Operations of the time-series data anomaly detection apparatus 100 will be described later. Note that time-series data anomaly detection apparatus 100 may also be referred to as an anomaly detection apparatus.

### (Example of Hardware Configuration)

The time-series data anomaly detection apparatus 100 can be implemented by, for example, causing a computer to execute a program.

In other words, the time-series data anomaly detection apparatus 100 can be implemented by executing a program corresponding to processing executed by the time-series data anomaly detection apparatus 100, by using hardware resources such as a CPU, a memory, and the like embedded in the computer. In other words, calculation of approximation of a Perron-Frobenius operator, calculation of prediction, calculation of an index of dispersion level, and the like described later can be implemented by the CPU that executes processing expressed in formulas corresponding to these calculations according to the program. Parameters corresponding to the formulas, data to be calculated, and the like are stored in a storage unit such as the memory, and when the CPU executes the processing, the CPU reads the data and the like from the storage unit to execute the processing.

The program described above can be recorded on a computer-readable recording medium (portable memory, etc.), to be stored and distributed. Also, the program described above can also be provided via a network such as the Internet, e-mail, and the like.

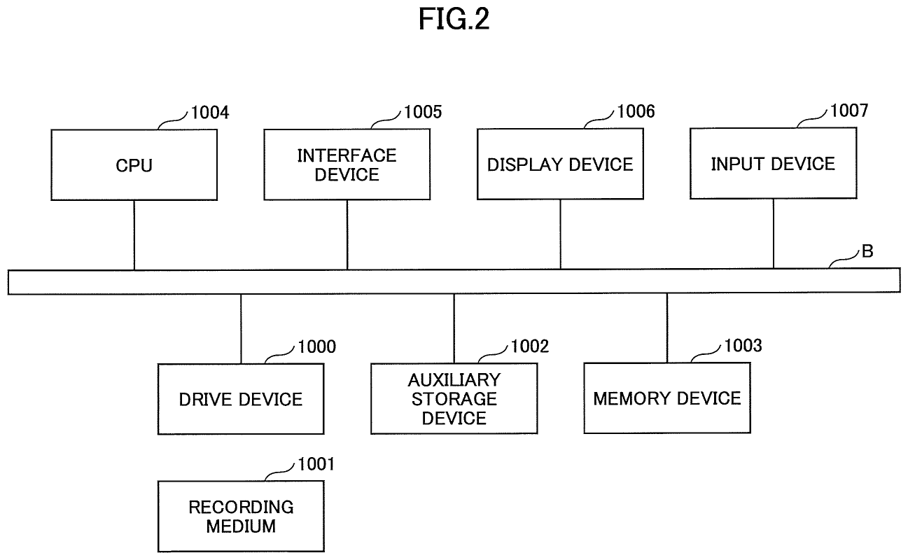

FIG. 2 is a diagram illustrating an example of a hardware configuration of the computer described above. The computer in FIG. 2 includes a drive device 1000, an auxiliary storage device 1002, a memory device 1003, a CPU 1004, an interface device 1005, a display device 1006, and an input device 1007, which are connected with each other via a bus B.

A program that implements processing on the computer is provided by a recording medium 1001 such as a CD-ROM. When the recording medium 1001 storing the program is set into the drive device 1000, the program is installed in the auxiliary storage device 1002 from the recording medium 1001 through the drive device 1000. However, installation of the program does not need to be done from the recording medium 1001; the program may be downloaded from another computer via a network. The auxiliary storage device 1002 stores the installed program and stores necessary files, data, and the like.

The memory device 1003 reads the program from the auxiliary storage device 1002, and stores the program when an activation command of the program is received. The CPU 1004 implements functions related to the time-series data anomaly detection apparatus 100 according to the program stored in the memory device 1003. The interface device 1005 is used as an interface for connecting to a network, and functions as an input unit and an output unit via the network. The display device 1006 displays a GUI (Graphical User Interface) or the like based on a program. The input device 1007 is constituted with a keyboard and a mouse, buttons, a touch panel, or the like, and is used for inputting various operational commands.

### (Overview of Operations of Time-Series Data Anomaly Detection Apparatus 100)

An overview of operations of the time-series data anomaly detection apparatus 100 is as follows. The time-series data anomaly detection apparatus 100 executes anomaly detection of time-series data by executing an approximation step and an anomaly detection step, as follows.

### <Approximation Step>

Step 0: The observed data obtaining unit 110 obtains observed data in time series up to time T. The observed data is, for example, data of a traffic volume obtained from a router or the like that constitutes a network.

Step 1: the Perron-Frobenius operator approximation unit 121 approximates a Perron-Frobenius operator on an RKHS that represents a mathematical model to generate the data by using the obtained observed data.

Step 2: from predictions with respect to the respective observed data items, the dispersion level calculating unit 122 uses the approximated Perron-Frobenius operator, to calculate a dispersion level of the predictions.

### <Anomaly Detection Executing Step>

Step 3: the observed data obtaining unit 110 obtains an observed data item at time t and an observed data item at time t+1.

Step 4: the detection unit 130 uses the Perron-Frobenius operator approximated at the approximation step, to predict a data item at time t+1 from the observed data item at time t.

Step 5: the detection unit 130 calculates discrepancy between the observed data at time t+1 and the predicted data at time t+1.

Step 6: the detection unit 130 determines a threshold value of anomaly taking into account the dispersion level of the prediction calculated at Step 2, and if the discrepancy calculated at Step 5 is greater than the threshold value, regards the observed data at time t+1 as anomalous.

### (Details of Operations of Time-Series Data Anomaly Detection Apparatus 100)

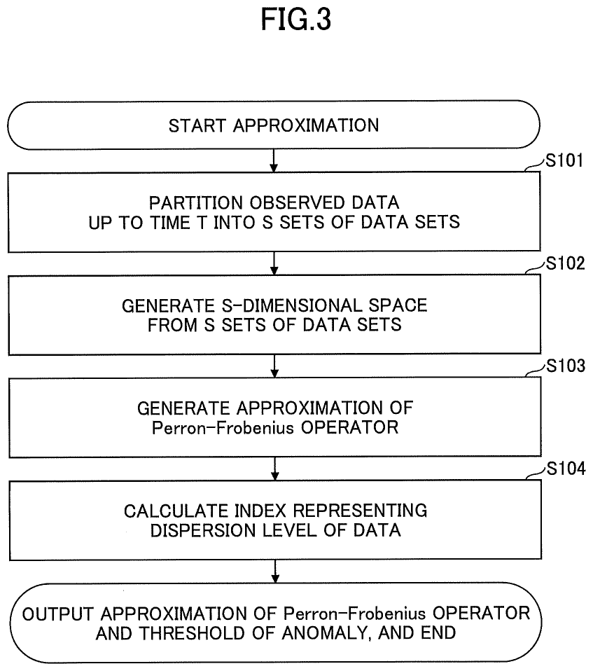

Details of the operations of the time-series data anomaly detection apparatus 100 will be described with reference to flow charts in FIGS. 3 to 5.

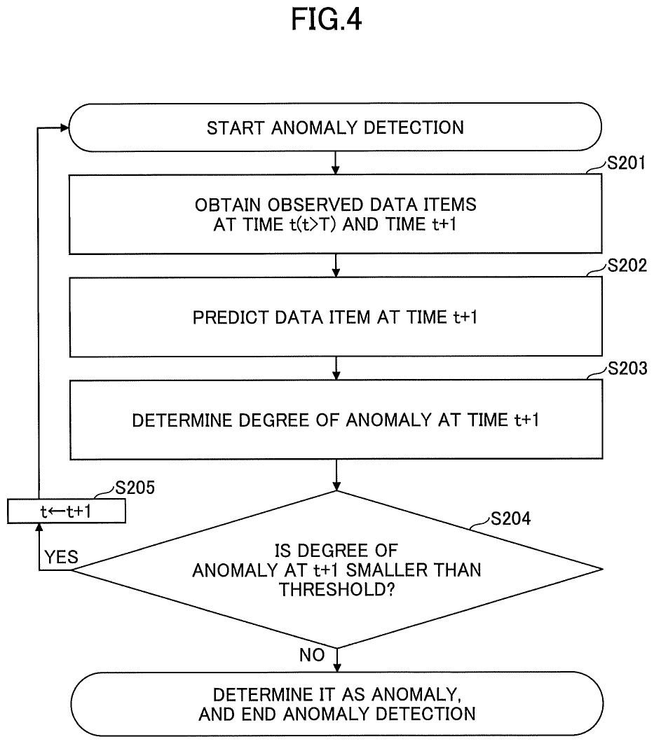

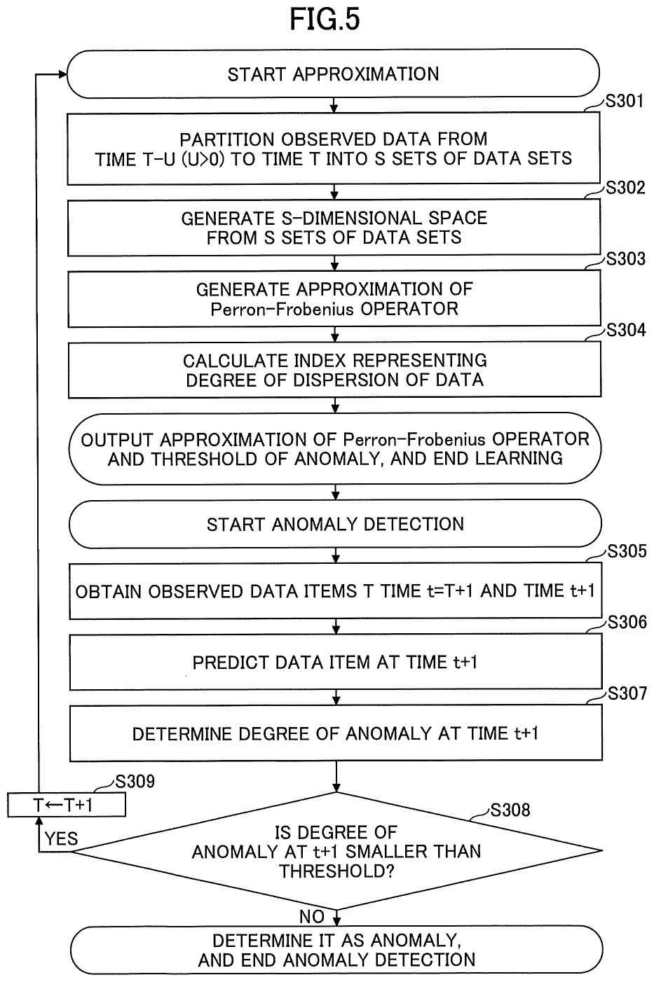

FIGS. 3 and 4 illustrate a method of continuously executing the anomaly detection executing step for t>T where T is fixed and the approximation step is executed only once (referred to as Method 1). FIG. 5 illustrates a method of executing anomaly detection by increasing T and setting t=T+1 for each increment (referred to as Method 2).

Compared to Method 1, Method 2 can better reflect latest information; therefore, this is more suitable in the case where a trend changes little by little over a long period of time. However, Method 2 requires a greater calculation amount than Method 1; therefore, in the case where real-time detection is required for time-series data within a short duration, Method 1 is more suitable. In the following, each of Method 1 and Method 2 will be described. Note that observed data described below may be data obtained in real time, or may be observed data in the past obtained from a server or the like. In either case, in the time-series data anomaly detection apparatus 100, the observed data is stored in a storage unit such as the memory, read from the storage unit, and used.

### <Method 1>

The approximation unit 120 of the time-series data anomaly detection apparatus 100 starts approximation.

In FIG. 3, at Step 101, the Perron-Frobenius operator approximation unit 121 partitions observed data up to a time T obtained by the observed data obtaining unit 110 into S sets of data sets (where S is an integer greater than or equal to 0).

At Step 102, the Perron-Frobenius operator approximation unit 121 generates an S-dimensional space from the S sets of data sets by an operation called orthogonalization.

At Step 103, the Perron-Frobenius operator approximation unit 121 generates an approximation of a Perron-Frobenius operator in the generated S-dimensional space that represents a mathematical model to generate the obtained observed data, by a function of restricting the behavior of the Perron-Frobenius operator on the RKHS.

At Step 104, the dispersion level calculating unit 122 uses the generated approximation of the operator, to calculate an index representing the dispersion level of the data, by a function of calculating the dispersion level of predictions with respect to the observed values, so as to set a larger threshold value, the smaller this index value is.

The approximation unit 120 outputs the approximation of the Perron-Frobenius operator and the threshold value of anomaly, and ends processing.

In FIG. 4, the detection unit 130 starts anomaly detection.

At Step 201, the observed data obtaining unit 110 obtains an observed data item at time t (t>T) and an observed data item at time t+1.

At Step 202, the detection unit 130 uses the approximation of the Perron-Frobenius operator output at the end of the approximation step illustrated in FIG. 3, to predict a data item at time t+1, by using a function of predicting the data item at time t+1 from the observed data item at time t.

At Step 203, the detection unit 130 determines the anomaly level at time t+1, by a function of calculating the discrepancy between the predicted data item at time t+1 and the observed data item.

At Step 204, the detection unit 130 determines whether the anomaly level at t+1 is less than the threshold value, and if yes, sets t+1 as t, and returns to the beginning; or if no, determines that the observed data is anomalous, and ends anomaly detection. Note that even in the case where that the observed data is determined as anomalous, the process may return to the beginning to repeat.

### <Method 2>

In FIG. 5, the approximation unit 120 of the time-series data anomaly detection apparatus 100 starts approximation.

At Step 301, the Perron-Frobenius operator approximation unit 121 partitions observed data from time T-U (U>0) to time T obtained by the observed data obtaining unit 110 into S sets of data sets.

At Step 302, the Perron-Frobenius operator approximation unit 121 generates an S-dimensional space from the S sets of data sets by an operation called orthogonalization.

At Step 303, the Perron-Frobenius operator approximation unit 121 generates an approximation of the Perron-Frobenius operator in the generated S-dimensional space that represents a mathematical model to generate the obtained observed data, by a function of restricting the behavior of the Perron-Frobenius operator on the RKHS.

At Step 304, the dispersion level calculating unit 122 uses the generated approximation of the operator, to calculate an index representing the dispersion level of the data, by a function of calculating the dispersion level of predictions with respect to the observed values, so as to set a larger threshold value for a smaller value of the index.

The approximation unit 120 outputs the approximation of the Perron-Frobenius operator and the threshold value of anomaly, and ends learning.

Next, the detection unit 130 starts anomaly detection.

At Step 305, the observed data obtaining unit 110 obtains an observed data item at time t=T+1 and an observed data item at time t+1.

At Step 306, the detection unit 130 uses the approximation of the Perron-Frobenius operator output at the end of the learning step, to predict a data item at time t+1, by using a function of predicting the data item at time t+1 from the observed data item at time t.

At Step 307, the detection unit 130 determines the anomaly level at time t+1, by a function of calculating the discrepancy between the predicted data item at time t+1 and the observed data item.

At Step 308, the detection unit 130 determines whether the anomaly level at t+1 is less than the threshold value, and if yes, sets T+1 as T, and returns to the beginning; or if no, determines it as anomalous, and ends anomaly detection. Note that even in the case where it is determined as anomalous, the process may return to the beginning to repeat.

### (Description of Calculation Methods)

In the following, calculation methods executed by the time-series data anomaly detection apparatus 100 will be described in detail. In addition, evaluation results will also be described. Note that in the following description, due to limitation on usable characters in the plain text in the specification, ‘˜’ to be attached above a character may be attached as the prefix of the character (e.g., ^{˜}K). Also, ‘\hat{ }’ to be attached above a character may be attached as the prefix of the character (e.g., \hat{ }K).

### <0. Problem Settings>

In the description here, it is assumed that time-series data is generated from the following mathematical model.

Xₜ₊₁=h(Xₜ)+ξₜ (1)

where Xₜ and ξₜ are random variables from a state space x (compact distance space) to a probability space (Ω,F), and h is a nonlinear mapping from X to X. Assume that a probability measure P is defined on Ω. ξₜ(t=0,1, . . . ) is an independent and identically distributed random variable representing noise, and is also independent from ξₜ and Xₜ.

Let k be a bivariate function with respect to x, being a measurable, bounded continuous function that satisfies the following two conditions:

Condition 1: for any x,yϵX, k(x,y)=k(y,x)

Condition 2: for any xᵢ, . . . , xⱼϵ_{X} and c₁, . . . , cₙ∈R, Σⁿ_{i,j=1}cᵢcⱼk (xᵢ, xⱼ)≥0

where k is referred to as kernel. For xϵ_{X}, let φ(x) be a function k(x,y) with respect to y. A reproducing kernel Hilbert space(RKHS) with respect to k is an infinite-dimensional function space of all linear combinations of φ(x) and their limits.

Here, the RKHS with respect to k is denoted as Hₖ. In Hₖ, the concept of inner product can be applied to elements of Hₖ, by defining the inner product of φ(x) and φ(y) by k(x,y).

By introducing this concept of inner product, the theory of linear algebra can be used in Hₖ. Assume that Hₖ is dense in the space constituted with all bounded continuous functions.

As k that satisfies the conditions described above, a Gaussian kernel k(x,y) =e^{-c||x-y||\hat{ }2}, a Laplacian kernel k(x,y)=e^{-c|x-y|}, and the like are available, and these are used in many applications.

By converting the random variable into a probability measure, the relationship of Equation (1) is converted into a relationship using the probability measure, and the following equation is obtained:

[Formula 1]

Xₜ₊₁,P=Fₜ, (Xₜ, P⊗P) (1)

where with respect to the random variable X, XIP is a probability measure determined by X*P(A)=P(X⁻¹ (A)) with respect to the set A, and Fₜ (x,ω)=h(x)+ξₜ (ω). By converting the random variable into the probability measure, by a concept called “kernel mean embedding” (Krikamol Muandet, Kenji Fukumizu, Bharath Sriperumbudur, and Bernhard Scholkopf.

Kernel mean embedding of distributions: A review and beyond. Foundations and Trends in Machine Learning, 10(1-2), p.p. 1-141, 2017), the probability measure can be embedded in Hₖ.

The kernel mean embedding with respect to a signed measure μ is a mapping Φ from the signed measure to Hₖ defined by Φ(μ)=∫_{xϵX}φ(x) dμ(x). Φ can be shown to be continuous and linear. A Perron-Frobenius operator K on the RKHS Hₖ is an operator defined as follows:

[Formula 2]

KΦ(X,P)=Φ(Fₜ, (X,P⊗P)) 2

It is possible to show that K is defined as a mapping, K is independent of t, and K is linear.

### <1. Approximation of Perron-Frobenius Operator on RKHS>

An approximation method of a Perron-Frobenius operator executed by the Perron-Frobenius operator approximation unit 121 will be described.

### 1.1. Arnoldi Method

Let {x₀, x₁, . . . , x_{T-1}} be observed data. This observed data is partitioned into S sets of data sets {x₀, x_{S}, . . . , X_{(N-1)s}}, {X₁,X₁₊ₛ, . . . , X_{1+(N-1)S})}, . . . , {x_{S-1}, x_{S-1+S}, . . . , x_{S-1+(N-1LS}}, and μ_{t,N} is introduced as follows:

$$[ Formula 3 ] \\ {μ}_{l , N} = \frac{1}{N} {\sum }_{i = 0}^{N - 1} {δ}_{{x}_{t + iS}} ( t = 0 , 1 , … , S - 1 )$$

where δₓ with respect to an element x of X is a probability measure that returns, with respect to a set A, if xϵA, then δₓ (A)=1, or

[Formula 4]

if x ∉A then S_{x 6l (A)=}0 (4)

μ_{t,N} can be calculated based on only the observed data. Here, with introducing Ψ_{0,N} as Ψ_{0,N}=[Φ(μ_{0,N}), . . . , Φ(μ_{s-1,N}L], the following relationship holds:

[Formula 5]

[Φ(F₀,(μ_{0,N}⊗P)), . . . , Φ(F₀, (μ_{0,N}⊗P))]=KΨ_{0,N}(2) (5)

Using Equation (2), an operator whose K is restricted to a space constituted with Φ(μ_{0,N}), . . . , Φ(μ_{s-1,N}) is calculated. However, in practice, the following expression cannot be calculated,

[Formula 6]

Φ(F₀, (μ_{0,N}⊗P)), . . . , Φ(F₀,(μ_{0,N}⊗P)) (6)

and hence, it is approximated from a finite number of observed data items. The following condition that the spatial mean is coincident with the time mean is assumed.

$$\begin{matrix}[ Formula 7 ] & \\ {lim}_{N \to ∞} \frac{1}{N} {\sum }_{i = 0}^{N - 1} {\int }_{ω ii Ω} ϕ ( h ( {x}_{i + iX} ) + {ξ}_{i} ( ω ) ) dP ( ω ) = {lim}_{N \to ∞} \frac{1}{N} {\sum }_{i = 0}^{N - 1} ϕ ( h ( {x}_{i + iX} ) + {ξ}_{i + iX} ( {ω}_{0} ) ) & ( 3 )\end{matrix}$$

where ω₀ ∈Ω is a latent state in the observed data.

The left side of Equation (3) is coincident with the following expression:

$$[ Formula 8 ] \\ {lim}_{N \to ∞} Φ ( {F}_{0} , ( {μ}_{t , N} ⊗ P ) )$$

and the right side is coincident with the following expression:

$$[ Formula 9 ] \\ {lim}_{N \to ∞} Φ ( {μ}_{t + 1 , N} )$$

Since Φ(μ_{t+1,N}) can be calculated based on only the observed data, the following expression,

[Formula 10]

Φ(F₀,(μ_{t,N}⊗P)) (10)

is approximated by Φ(μ_{t+1,N}).

In the case where K has a good property of being bounded, when in N->∞ in Equation (2), the following equation holds:

$$[ Formula 11 ] \\ {lim}_{N \to ∞} K Φ ( {μ}_{t , N} ) = K {lim}_{N \to ∞} Φ ( {μ}_{t , N} )$$

Therefore, the following equation holds:

[Φ(μ₁), . . . , Φ(μₛ)]=K[Φ(μ₀), . . . , Φ(μₛ₋₁)] (4)

where

$$[ Formula 12 ] \\ {μ}_{t} = {lim}_{N \to ∞} {μ}_{t , N}$$

In this way, by approximating Φ(μₜ) by Φ(μ_{t,N}) for each t=0, . . . , S, from a finite number of data items, K can be restricted approximately to a space including all the linear combinations of Φ(μ₀), . . . , Φ(μₛ₋₁). QR decomposition is executed to obtain [Φ(μ_{0,N}), . . . , Φ(μ_{s-1,N})]=Q_{S,N}R_{S,N}. The calculation method of Q_{S,N}⋅R_{S,N} will be described in Section 1.1.1. Denoting the restricted operator as ^{˜}K_{S,N}^{Arnoldi}, it can be calculated as follows:

[Formula 13]

\tilde{K}_{S,N}^{Arnoldi}=Q^{x}_{S,N}[Φ(μ_{1,N}), . . . ,Φ(μ_{S,N})]R_{S,N}⁻¹ (5)

It can be seen from Equation (4) that the space including all the linear combinations of Φ(μ₀), . . . , Φ(μ_{S-1}) is the same space as a space called the Krylov subspace used in the most standard Krylov subspace method called the Arnoldi method. Therefore, the present method can be regarded as approximate execution of the Arnoldi method using observed data.

### 1.1.1. Specific Calculation Method

By applying QR decomposition to Ψ_{0,N} to obtain Ψ_{0,N}=Q_{S,N}R_{S,N}, a conversion of the space including all the linear combinations of Φ(μ_{0,N}), . . . , Φ(μ_{S-1,N}) into a representation using an orthonormal basis, or Q_{S,N}, can be obtained.

Specifically, when an orthonormal basis of q_{0,N}, . . . , q_{t-1,N}, q_{t,N} is obtained by making Φ(μ_{t,N}) orthonormal to q_{0,N}, . . . , q_{t-1,N}, q_{t,N}, and then, Q_{S,N} as a conversion from C^{S} to Hₖ is defined by the following conversion:

[Formula 14]

[z₀, . . . ,z_{S-1}] [symbol] z₀q₀+. . . , +z_{S-1}q_{S-1} (14)

q_{t,N} is calculated using the following equation:

$$[ Formula 15 ] \\ = Φ ( {μ}_{t , N} ) - {\sum }_{i = 0}^{t - 1} {〈 Φ ( {μ}_{t , N} ) , {q}_{l , N} 〉}_{k} {q}_{l , N} \\ {q}_{t , N} = / {‖ ‖}_{k}$$

where <⋅,⋅>ₖ denotes the inner product on the RKHS, and the calculation method will be described as follows. R_{S,N} is an S×S matrix, a component (i,t) of R_{S,N} is denoted as r_{i,t}, and for i<t, defined as <Φ(μ_{t,N}), qᵢ>ₖ; for i=t, defined as

[Formula 16]

[symbol]

/∥ [symbol] ∥_{K} (16)

and for i>t, defined as 0. At this time, it can be expressed as follows:

[Formula 17]

q_{i,N}=(Φ(μ_{i,N})-Σⱼ₌₀ⁱ⁻¹r_{j,i}q_{j,N})/r_{i,t} (17)

Then, for i<t, r_{i,t} can be calculated as follows:

$$[ Formula 18 ] \\ \begin{matrix}{r}_{l , t} = {〈 \frac{Φ ( {μ}_{l , N} ) - {\sum }_{j = 0}^{i - 1} {r}_{j , i} {q}_{j}}{{r}_{l , i}} , Φ ( {μ}_{t , N} ) 〉}_{k} \\ = \frac{{〈 Φ ( {μ}_{l , N} ) , Φ ( {μ}_{t , N} ) 〉}_{k} - {\sum }_{j = 0}^{i - 1} {r}_{j , l} {〈 {q}_{j} , Φ ( {μ}_{t , N} ) 〉}_{k}}{{r}_{l , i}} \\ = \frac{{〈 Φ ( {μ}_{l , N} ) , Φ ( {μ}_{t , N} ) 〉}_{k} - {\sum }_{j = 0}^{i - 1} {r}_{j , i} {r}_{j , t}}{{r}_{l , i}}\end{matrix}$$

where <Φ(μ_{i,N}), Φ(μ_{t,N})>ₖ can be calculated as follows:

$$[ Formula 19 ] \\ \begin{matrix}{〈 Φ ( {μ}_{l , N} ) , Φ ( {μ}_{t , N} ) 〉}_{k} = {\sum }_{l , m = 0}^{N - 1} {〈 \frac{1}{N} Φ ( {δ}_{{x}_{i + mS}} ) , \frac{1}{N} Φ ( {δ}_{{x}_{t + lS}} ) 〉}_{k} \\ = \frac{1}{{N}^{2}} {\sum }_{l , m = 0}^{N - 1} {〈 Φ ( {δ}_{{x}_{i + mS}} ) , Φ ( {δ}_{{x}_{t + iS}} ) 〉}_{k} \\ = \frac{1}{{N}^{2}} {\sum }_{l , m = 0}^{N - 1} {〈 ϕ ( {x}_{i + mS} ) , ϕ ( {x}_{t + iS} ) 〉}_{k} \\ = \frac{1}{{N}^{2}} {\sum }_{l , m = 0}^{N - 1} k ( {x}_{i + mS} , {x}_{t + lS} )\end{matrix}$$

Also, ∥⋅∥ₖ is a norm in the RKHS, and calculated by the following equation:

[Formula 20]

∥ [symbol] |ₖ= [symbol] (20)

When i=j, <q_{i,N},q_{i,N}>ₖ=1, and when i≠j, <q_{i,N},q_{i,N}>ₖ=1; therefore, r_{t,t} can be calculated as follows:

$$[ Formula 21 ] \\ \begin{matrix}{r}_{j , t}^{2} = {〈 , 〉}_{k} \\ = {〈 Φ ( {μ}_{t , N} ) - {\sum }_{j = 0}^{t - 1} {〈 Φ ( {μ}_{t , N} ) , {q}_{j , N} 〉}_{k} {q}_{j , N} , Φ ( {μ}_{t , N} ) - {\sum }_{j = 0}^{t - 1} {〈 Φ ( {μ}_{t , N} ) , {q}_{j , N} 〉}_{k} {q}_{j , N} 〉}_{k} \\ = {〈 Φ ( {μ}_{t , N} ) - {\sum }_{j = 0}^{t - 1} {r}_{j , t} {q}_{j , N} , Φ ( {μ}_{t , N} ) - {\sum }_{j = 0}^{t - 1} {r}_{j , t} {q}_{j , N} 〉}_{k} \\ = {〈 Φ ( {μ}_{t , N} ) , Φ ( {μ}_{t , N} ) 〉}_{k} - 2 ℛ {〈 Φ ( {μ}_{t , N} ) , Φ ( {μ}_{t , N} ) - {\sum }_{j = 0}^{t - 1} {r}_{j , t} {q}_{j , N} 〉}_{k} + {〈 {\sum }_{j = 0}^{t - 1} {r}_{j , t} {q}_{j , N} , {\sum }_{j = 0}^{t - 1} {r}_{j , t} {q}_{j , N} 〉}_{k} \\ = {\sum }_{j , l = 0}^{N - 1} k ( {x}_{t + jS} , {x}_{t + iS} ) - 2 {\sum }_{j = 0}^{t - 1} {r}_{j , t} \overline{{r}_{j , t}} + {\sum }_{j = 0}^{t - 1} {r}_{j , t} \overline{{r}_{j , t}} \\ = {\sum }_{j , l = 0}^{N - 1} k ( {x}_{t + jS} , {x}_{t + iS} ) - {\sum }_{j = 0}^{t - 1} {\vert {r}_{j , t} \vert}^{2}\end{matrix}$$

In Equation (5), [Φ(μ_{1,N}), . . . , Φ(μ_{S,N})] is a conversion from C⁵ to Hₖ expressed as follows:

[Formula 22]

[z₀, . . . ,zₙ₋₁] [symbol] z₀Φ(μ_{1,N})+ . . . ,+z_{S-1}Φ(μ_{S,N}) (22)

Q*_{S,N} is a conversion from Hₖ to C^{S} expressed as follows:

[Formula 23]

v [symbol] [ [symbol] v,q₀ [symbol] ₖ, . . . , [symbol] v,qₛ₋₁ [symbol] ₖ] (23)

Therefore, Q*_{S,N} [Φ(μ_{1,N}), . . . , Φ(μ_{S,N})] corresponds to an S×S matrix whose (i,t) component is <Φ(μ_{t+1,N}), qᵢ>ₖ, and hence, can be calculated in substantially the same way as r_{i,t}.

### 1.2. Shift-invert Arnoldi Method

In the case where K is not bounded, a limiting state of N->∞ cannot be considered; therefore, the validity of the approximation by observed data cannot be shown. Therefore, by selecting a complex number y such γ such that (γI-K)⁻¹ becomes bounded and bijective to approximate (γI-K)⁻¹, this problem is solved. Since (γI-K)⁻¹ is bounded, the following equation holds:

$$[ Formula 24 ]$$

$${lim}_{N \to ∞} {( γ I - K )}^{- 1} Φ ( {μ}_{t , N} ) = {( γ I - K )}^{- 1} {lim}_{N \to ∞} Φ ( {μ}_{t , N} ) \qquad [ Formula 24 ]$$

and assuming Equation (3), the following equation holds:

$$[ Formula 25 ]$$

$${lim}_{N \to ∞} {( γ \text{?} - K )}^{- 1} = ( γΦ ( {μ}_{1 , N} ) - Φ ( {μ}_{t + 1 , N} ) ) = {( γ \text{?} - K )}^{- 1} {lim}_{N \to ∞} ( γΦ ( {μ}_{1 , N} ) ⋯ Φ ( {μ}_{\text{?}} ) ) = {( γ \text{?} - K )}^{- 1} {lim}_{N \to ∞} ( γΦ ( {μ}_{1 , N} ) - Φ ( {F}_{\text{?}} ( {μ}_{t , N} ⊗ P ) ) ) = {( γ \text{?} - K )}^{- 1} {lim}_{N \to ∞} ( γΦ ( {μ}_{t , N} ) - K Φ ( {μ}_{t , N} ) ) = {( γ \text{?} - K )}^{- 1} {( γ \text{?} - K )}^{- 1} {lim}_{N \to ∞} Φ ( {μ}_{t , N} ) = {lim}_{N \to ∞} Φ ( {μ}_{t , N} )$$

$$\text{?} \text{indicates text missing or illegible when filed}$$

Therefore, for j=0, . . . , S, the following equation holds:

$$[ Formula 26 ]$$

$${( γ \text{?} - K )}^{- 1} {\sum }_{t = 0}^{j} ( \begin{matrix}j \\ t\end{matrix} ) {( - 1 )}^{t} {γ}^{j - t} ( γΦ ( {μ}_{t} ) - Φ ( {μ}_{t + 1} ) ) = {\sum }_{t = 0}^{j} ( \begin{matrix}j \\ t\end{matrix} ) {( - 1 )}^{t} {γ}^{j - t} Φ ( {μ}_{t} ) = {\sum }_{t = 0}^{j - 1} ( \begin{matrix}j - 1 \\ t\end{matrix} ) {( - 1 )}^{t} {γ}^{j - 1 - t} ( γΦ ( {μ}_{t} ) - Φ ( {μ}_{t + 1} ) )$$

$$\text{?} \text{indicates text missing or illegible when filed}$$

Therefore, the following equation holds:

$$[ Formula 27 ]$$

$${( γ \text{?} - K )}^{- 1} [ \text{} γΦ ( {μ}_{0} - Φ ( {μ}_{1} ) , … , {\sum }_{t = 0}^{S - 1} ( \begin{matrix}S - 1 \\ t\end{matrix} ) {( - 1 )}^{t} {γ}^{S - 2 - \text{?}} ( γΦ ( {μ}_{\text{?}} ) - Φ ( {μ}_{t + 1} ) ) ] = [ Φ ( {μ}_{0} ) , γΦ ( {μ}_{0} ) - Φ ( {μ}_{1} ) , … , {\sum }_{i = 0}^{S - 2} ( \begin{matrix}S - 2 \\ t\end{matrix} ) {( - 1 )}^{t} {γ}^{S - 2 - \text{?}} ( γΦ ( {μ}_{t} ) - Φ ( {μ}_{t + 1} ) ) ]$$

$$\text{?} \text{indicates text missing or illegible when filed}$$

For each t=0, S, by approximating Φ(μₜ) with Φ(μ_{t,N}), from a finite number of data items, (γI-K)⁻¹ can be approximately restricted to a space including all of the following linear combinations:

$$[ Formula 28 ]$$

$$γΦ ( {μ}_{0} ) - Φ ( {μ}_{1} ) , … , {\sum }_{t = 0}^{S - 1} ( \begin{matrix}S - 1 \\ t\end{matrix} ) {( - 1 )}^{t} {γ}^{s - 1 - t} ( γΦ ( {μ}_{t} ) - Φ ( {μ}_{t + 1} ) )$$

$$[ Formula 29 ]$$

$${ψ}_{0 , N} = [ γΦ ( {μ}_{0 , N} ) - Φ ( {μ}_{1 , N} ) , … , {\sum }_{t = 0}^{S - 1} ( \begin{matrix}S - 1 \\ t\end{matrix} ) {( - 1 )}^{t} {γ}^{S - 1 - t} ( γΦ ( {μ}_{\text{?}} ) - Φ ( {μ}_{\text{?}} ) ) ] = [ γΦ ( {μ}_{0 , N} ) - Φ ( {μ}_{1 , N} ) , … , {\sum }_{t = 0}^{S} ( \begin{matrix}S \\ t\end{matrix} ) {( - 1 )}^{t} {γ}^{\text{?}} Φ ( {μ}_{0 , N} ) ]$$

$$\text{?} \text{indicates text missing or illegible when filed}$$

With the above expression, QR decomposition is applied to obtain Ψ_{0,N}=Q_{S,N}R_{S,N}. The calculation method of Q_{S,N}⋅R_{S,N} is simply to replace Φ(μ_{j,N}) in Section 1.1.1 with the following:

$$[ Formula 30 ]$$

$${\sum }_{t = 0}^{j + 1} ( \begin{matrix}j + 1 \\ t\end{matrix} ) {( - 1 )}^{t} {γ}^{j + 1 - t} Φ ( {μ}_{t} )$$

By using this, the behavior of (γI-K)⁻¹ can be restricted to the space that includes all the linear combinations.

$$[ Formula 31 ]$$

$${ψ}_{1 , N} = [ Φ ( {μ}_{0 , N} ) , … , {\sum }_{t = 0}^{S - 1} ( \begin{matrix}S - 1 \\ t\end{matrix} ) {( - 1 )}^{t} {γ}^{j - t} Φ ( {μ}_{t , N} ) ]$$

With the above expression, as in Section 1.1, (γI-K)⁻¹ is approximated from a finite number of observed data items by \hat{ }K_{S,N} defined as follows:

[Formula 32]

\tilde{K}_{S,N}=Q_{S,N}⁺Ψ_{1,N}R_{S,N}⁻¹ (32)

Even in the case where K is not bounded, (γI-K)⁻¹ is bounded; therefore, as in Section 1.1, the present method can be regarded as approximate execution of the Arnoldi method with respect to (γI-K)⁻¹ by observed data. The Arnoldi method with respect to (665 I-K)⁻¹ is called the Shift-invert Arnoldi method.

Since K=γI-((γl-K)^{631 1})⁻¹, with the following equation,

[Formula 33]

\tilde{K}_{S,N}^{SIA}=γI−\tilde{K}_{S,N}⁻¹ (33)

K is approximated by ˜K_{S,N}^{SIA}.

### 1.3. Validity of Approximation Methods in Section 1.1 and Section 1.2

In the following, validity of approximation methods in Section 1.1 and Section 1.2 will be described.

The following proposition holds for Q_{S,N} R_{S,N} that appears in the approximation methods in Section 1.1 and Section 1.2.

### Proposition 1

In Section 1.1, Ψ₀ is expressed as Ψ₀=[(μ₀), . . . , Φ(μ^{S-1})], and in Section 1.2, Ψ₀ is expressed as follows,

$$[ Formula 34 ]$$

$${Ψ}_{0} = [ γΦ ( {μ}_{0} ) - ϕ ( {μ}_{1} ) , … , {\sum }_{t = 0}^{S} ( \begin{matrix}S \\ t\end{matrix} ) {( - 1 )}^{t} {γ}^{j - t} Φ ( {μ}_{t} ) ]$$

and let Ψ₀=Q_{S}R_{S} be the QR decomposition of Ψ₀. Let ˜KS=Q*_{S}Ψ₁R_{N}⁻¹. ˜K_{S,N}^{Arnoldi} and ˜K_{S,N}^{SIA} are collectively denoted as ˜K_{S,N}. At this time, with respect to Q_{S,N} and ˜K_{S,N} defined in Section 1.1 and in Section 1.2, Q_{S,N}->Q_{S}(strongly) and ˜K_{S,N}->˜K_{S} hold.

### <2. Anomaly Detection>

Next, a calculation method of anomaly detection will be described.

By using ˜K_{S,N}^{NArnoldi} and ˜K_{S,N}^{SIA} generated in Section 1.1 and in Section 1.2, respectively, anomaly detection is executed by predicting a data item to be observed at time t from an observed data item φ(xₜ₋₁) at time t−1, and calculating the discrepancy with an actual observed data item at time t. In the following, ˜K_{S,N}^{Arnoldi} and ˜K_{S,N}^{SIA} are collectively denoted as ˜K_{S,N}. The prediction is generated by the following expression:

[Formula 35]

Q_{S,N}\tilde{K}_{S,N}Q_{S,N}⁺Ø(Xᵣ₋₁) (35)

Therefore, the anomaly level aₜ that represents the discrepancy with an actual observation at time t is defined as follows:

$$[ Formula 36 ]$$

$${a}_{t} = \frac{{‖ {Q}_{S} {\tilde{K}}_{S} {Q}_{S}^{*} ϕ ( {x}_{t - 1} ) - ϕ ( {x}_{t} ) ‖}_{k}}{{G}_{S} ( r )} \\ where$$

$$[ Formula 37 ]$$

$${G}_{S} ( r ) = {max}_{z ∈ {Γ}_{r}} \vert {fp}_{s} ( z ) \vert , f ( z ) = γ - {z}^{- 1}$$

where p_{S} is a polynomial of (S631 1) dimensions that satisfies φ(xₜ₋₁)=pₛ ((γI-K) ⁻¹) μ_{S}, and the following expressions are introduced:

[Formula 38]

ûₛ=γ^{S-1}(γΦ(μ₀)−Φ(μ₁))- . . . +(−1)^{s-1}(γΦₛ₋₁)−Φ(μₛ)), μ_{S}=ûₛ/μûₛ∥ (38)

In the above, Γᵣ is a set that satisfies Γᵣ⊇Γₛ⊇ W((γI-K)⁻¹) for s≤r, where W((γI-K)⁻¹)={z=v*(γI-K)⁻¹|v∈Hₖ||v||ₖ=1}. With respect to the anomaly level aₜ, the following proposition holds:

### Proposition 2

In Section 1.2, the following expression is introduced:

[Formula 39]

\tilde{K}_{S}=Q_{S}Q_{S}⁺Ψ_{1:S}R_{S}⁻¹Q_{S}⁺,\tilde{K}_{S}^{SIA}=γ1−\tilde{K}_{S}⁻¹ (39)

Let R_{S} be a space including all the linear combinations of γΦ(μ₀)-Φ(μ₁), γ(γΦ(μ₀)-Φ(μ₁))-(γΦ(μ₁)-Φ(μ₂)), . . . , γ^{S-1} (γΦ(μ₀)−Φ(μ₁)-. . . +(−1)^{S-1}(γΦ(μ_{S-1})-Φ(μ_{S})). If 6100 (xₜ₋₁) is sufficiently close to R_{S}, there exist C₁,C₂,C₃>0 and 0<θ<1, and the following equation holds:

$$[ Formula 40 ]$$

$$\frac{{‖ ϕ ( {x}_{t} ) - {Q}_{S} {\tilde{K}}_{S} {Q}_{S}^{*} ϕ ( {x}_{t - 1} ) ‖}_{k}}{{G}_{S} ( r )} ≾ {C}_{1} {‖ {\int }_{ω ∈ Ω} ϕ ( h ( {x}_{t - 1} ) + {ξ}_{i} ( ω ) ) dP ( ω ) - ϕ ( {x}_{t} ) ‖}_{k} + {C}_{2} {min}_{u ∈ {K}_{S}} {‖ ϕ ( {x}_{t - 1} ) - u ‖}_{k} + \frac{{C}_{3} {θ}^{S}}{1 - θ} . \qquad ( 6 )$$

The first term on the right-hand side of Equation (6) represents the discrepancy between an expected value of observation and the actual observation, under assumption of xₜ₋₁ and xₜ conforming to the model of Equation (1). The second term takes a value close to zero if φ(xₜ₋₁) is sufficiently close to R_{S}. Since 0<θ<1, if S is sufficiently large, the third term takes a value close to zero. Therefore, if xₜ₋₁ and xₜ conform to the model of Equation (1), and φ(xₜ₋₁) is sufficiently close to R_{S}, then, aₜ takes a small value. Therefore, if aₜ is large, it can be stated that xₜ₋₁ and xₜ do not conform to the model of Equation (1), or φ(xₜ₋₁) is not close to R_{S}, namely, it is anomalous.

However, in practice, G_{S}(r) or Q_{S} cannot be calculated; therefore, the following value is used instead.

$$[ Formula 41 ]$$

$${\hat{a}}_{t , S , N} = \frac{{‖ {Q}_{S , N} {\tilde{K}}_{S , N} {Q}_{S , N}^{*} ϕ ( {x}_{t - 1} ) - ϕ ( {x}_{t} ) ‖}_{k}}{{‖ {Q}_{S , N} {\tilde{K}}_{S , N} {Q}_{S , N}^{*} ϕ ( {x}_{t - 1} ) ‖}_{k}}$$

Here, it can be shown that a certain C exists, and the following inequality is satisfied:

[Formula 42]

CG_{S}(r)≥∥Q_{S,N}\tilde{K}_{S,N}Q_{S,N}⁺Φ(xₜ₋₁)∥_{K} (42)

As such, if aₜ is large, \hat{ }a_{t,N} becomes large.

Therefore, if \hat{ }a_{t,S,N} is greater than the threshold value, it is regarded as anomalous, and if smaller, it is regarded as normal.

Upon setting the threshold value for anomaly, the randomness of predictions needs to be taken into account. Thereupon, a value of the following expression is used as the magnitude of the prediction on the RKHS:

[Formula 43]

∥Q_{S,N}\tilde{K}_{S,N}Q_{S,N}⁺Φ(xₜ₋₁)∥ₖ (43)

Let d(x,y) represent the distance between x,y∈X.

Let the kernel k be a function related to the distance, and can be expressed as k(x,y)=f(d(x,y)). Further, assume that f is a monotone decreasing function. The examples shown in Section 0., the Gaussian kernel k(x,y) =ₑ^{-c||x-y||\hat{ }2}, and the Laplacian kernel k(x,y)=e^{-c|x-y|} satisfy these conditions.

It is possible to show that any probability measure μ can be expressed in the following form:

$$[ Formula 44 ]$$

$$μ = {lim}_{N \to ∞} {\sum }_{i = 0}^{N - 1} {c}_{i} {δ}_{{x}_{i}}$$

With respect to μ, the magnitude of Φ(μ) on the RKHS is expressed as follows:

$${‖ Φ ( μ ) ‖}_{k}^{2} = {lim}_{N \to ∞} {\sum }_{i , j = 0}^{N - 1} {c}_{i} {c}_{j} f ( d ( {x}_{i} , {x}_{j} ) ) \qquad [ Formula 45 ]$$

While the weighted sum of f(d(xᵢ,xⱼ)) described above is smaller, the distance between xᵢ and xⱼ is greater; therefore, the dispersion expressed as follows,

$$[ Formula 46 ]$$

$$μ = {lim}_{N \to ∞} {\sum }_{i = 0}^{N - 1} {c}_{i} {δ}_{{x}_{i}}$$

spreads over a wide range.

[Formula 47]

Q_{S,N}\tilde{K}_{S,N}Q_{S,N}⁺Φ(xₜ₋₁) (47)

This expression is a prediction with respect to information on the probability measure at time t; therefore, in the case where it is predicted correctly,

[Formula 48]

∥Q_{S,N}\tilde{K}_{S,N}Q_{S,N}⁺Φ(xₜ₋₁)∥ₖ (48)

for a smaller value of the above, it can be considered that the dispersion of predictions is greater. Thereupon, by calculating values of the following expression for normal data,

[Formula 49]

∥Q_{S,N}\tilde{K}_{S,N}Q_{S,N}⁺Φ(xₜ₋₁)∥ₖ (49)

information on the randomness of the data can be extracted. This can be used for setting the threshold value such that in the case where the randomness is large, the threshold value for anomaly is set to be large; or if the randomness is small, the threshold value for anomaly is set to be small.

### <3. Evaluation Results>

In the following, evaluation results will be described.

### 3.1. Dispersion of Predictions

Time-series data {x₀, x₁, . . . , x_{T-1}} was generated as follows:

$$[ Formula 50 ]$$

$${x}_{t} = 6 + cos ( \frac{2 π}{40} t ) + 0.5 cos ( \frac{2 π}{20} t ) + 2 sin ( \frac{2 π}{5} t ) + 0.6 cos ( \frac{2 π}{4} t ) + {ξ}_{i}$$

where ξₜ takes values randomly sampled from a normal distribution with a mean of 0 and a standard deviation of σ. In order to confirm the relationship between the dispersion of predictions and the index expressed as

[Formula 51]

∥Q_{S,N}\tilde{K}_{S,N}Q_{S,N}⁺Φ(xₜ₋₁)∥ₖ (51)

˜K_{S,N} as the approximation of K was calculated for σ=1, 3, and 5, N=60, and S=30, and for each t for each σ, the following value was calculated:

[Formula 52]

∥Q_{S,N}\tilde{K}_{S,N}Q_{S,N}⁺Φ(xₜ₋₁)∥ₖ (52)

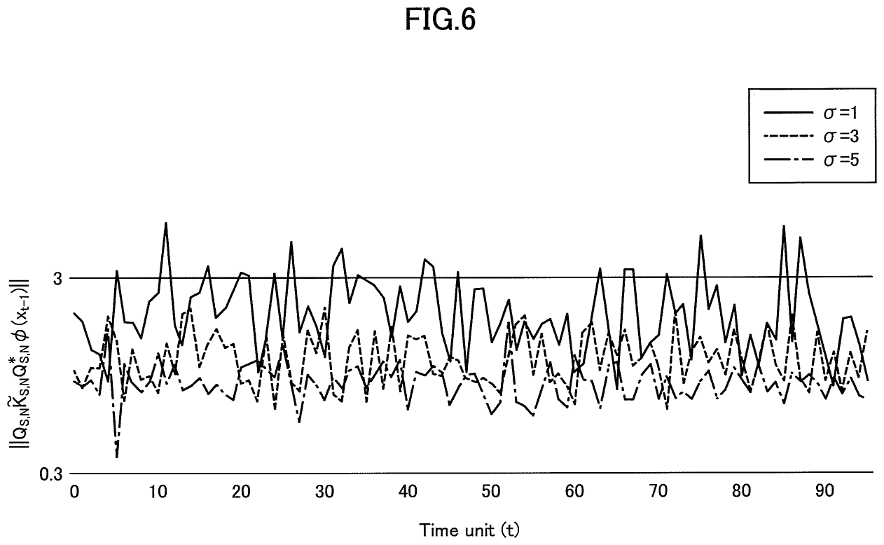

As the kernel, a Laplacian kernel k(x,y)=e^{-|x-y|} was used. The results were as illustrated in FIG. 6, where a greater dispersion of data resulted in a smaller value of magnitude expressed as follows:

[Formula 53]

∥Q_{S,N}\tilde{K}_{S,N}Q_{S,N}⁺Φ(xₜ₋₁)∥ₖ (53)

It can be considered that a greater dispersion of data makes the dispersion of predictions greater; therefore, it can be seen that the magnitude expressed as follows,

[Formula 54]

∥Q_{S,N}\tilde{K}_{S,N}Q_{S,N}⁺Φ(xₜ₋₁)∥ₖ (54)

can be used as an index of the dispersion of predictions.

### 3.2. Comparison of Arnoldi Method, Shift-invert Arnoldi Method, and Existing Method

With respect to traffic data published in http://totem.info.ucl.ac.be/dataset.html, the anomaly levels obtained by the Arnoldi method, the Shift-invert Arnoldi method, and an existing method were calculated. This data includes measurements of the traffic volume at each router at 15-minute intervals in a network that is constituted with 23 routers, 38 links between the routers, and 53 links with the outside.

Only a traffic volume transmitted from one particular router was extracted for 876 units of time, and the first 780 data items were used as training data, whereas the remaining 96 data items (for one day's worth) were used as normal data for testing.

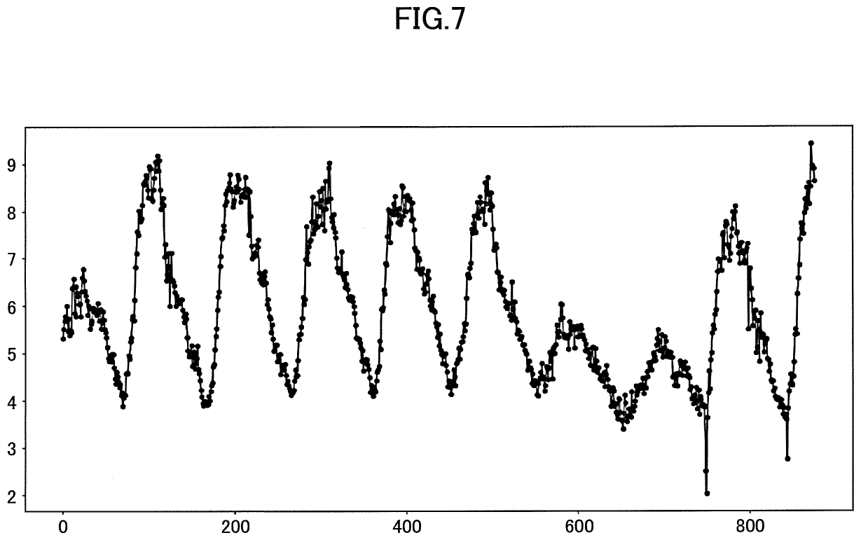

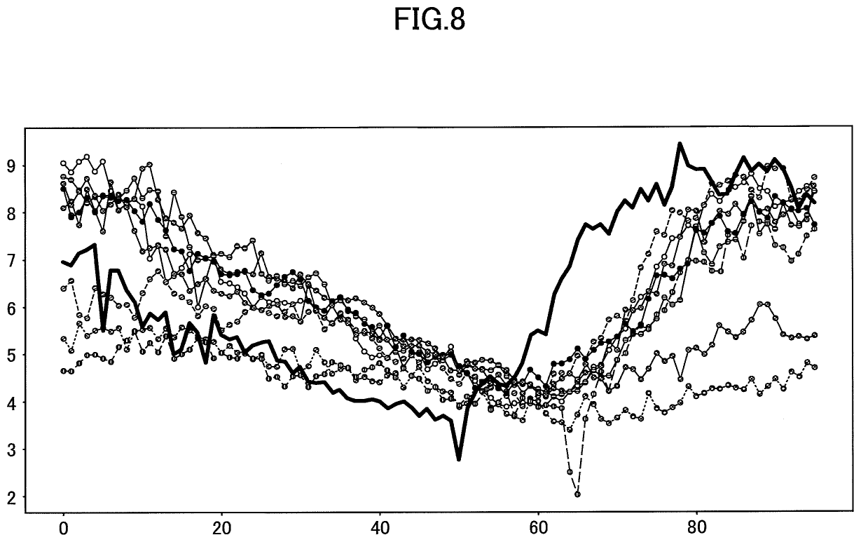

As anomalous data for testing, {10, 10, . . . , 10} was used. The data used are illustrated in FIGS. 7 and 8. FIG. 8 illustrates the data that has been separated for each day and then superimposed onto each other, where thin lines represent the training data and a thick line represents time-series data used as the normal data.

In the Arnoldi method and the Shift-invert Arnoldi method, ˜K_{S,N} as the approximation of K was calculated using the training data, and using the approximation, the respective anomaly levels of the normal data and the anomalous data were calculated. The setting values were N=60 and S=13. In the Shift-invert Arnoldi method, γ=1.25. As the kernel, the Laplacian kernel k(x,y)=e^{-|x-y|} was used.

Here, for data {z₀,z₁, z_{T-1}}, by regarding columns of three-dimensional vectors {x₀, x₁, . . . , x_{T-1}} where xᵢ=[zᵢ,zᵢ₊₁,zᵢ₊₂] as observed data, predictions were generated using information up to three units of time before, to calculate the anomaly levels.

As an existing method, a method using LSTM proposed in literature (Pankaj Malhotra, Lovekesh Vig, Gautam Shroff, and Puneet Agarwal. Long short term memory networks for anomaly detection in time series. In European Symposium on Artificial Neural Networks, Computational Intelligence and Machine Learning, p.p. 89-94, 2015), was used. The LSTM that generates predictions using information up to three units of time prior to the current time, was trained by using the training data, to calculate the anomaly levels proposed for the method in the literature (Pankaj Malhotra, Lovekesh Vig, Gautam Shroff, and Puneet Agarwal. Long short term memory networks for anomaly detection in time series. In European Symposium on Artificial Neural Networks, Computational Intelligence and Machine Learning, p.p. 89-94, 2015), for the normal data and the anomalous data.

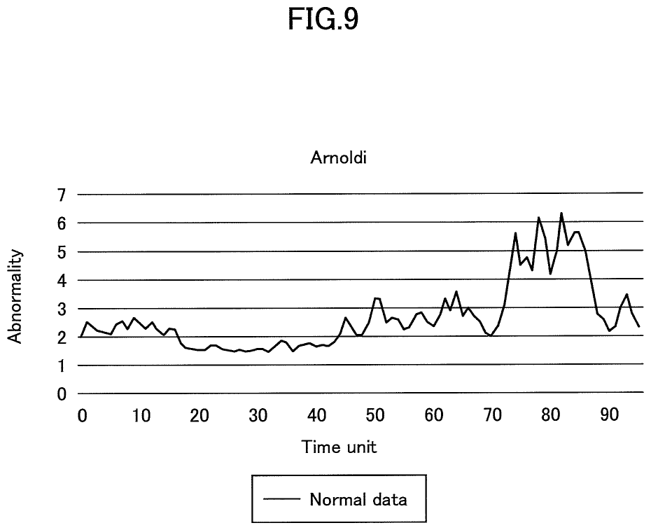

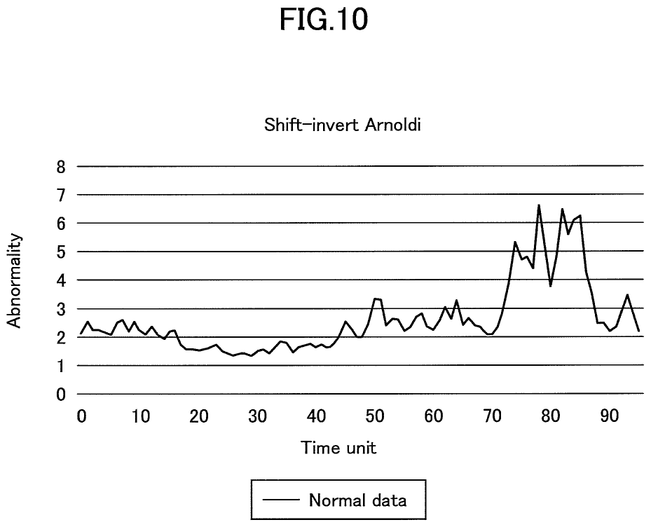

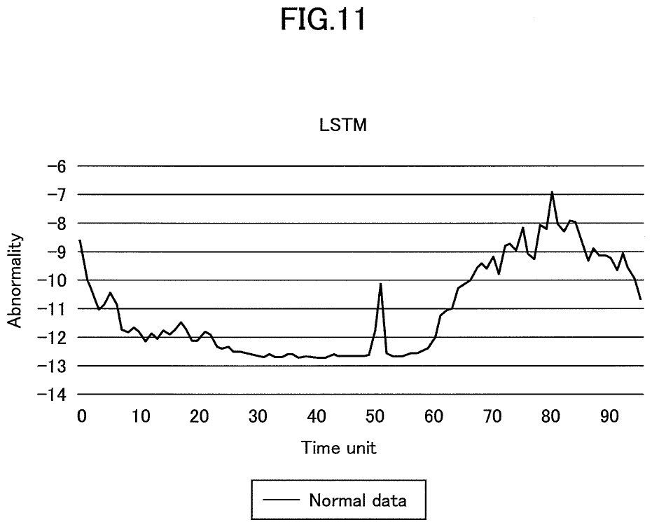

Results for the normal data are illustrated in FIGS. 9 to 11. FIG. 9 corresponds to the Arnoldi method, FIG. 10 corresponds to the Shift-invert Arnoldi method, and FIG. 11 corresponds to the LSTM method.

The anomalous data takes a constant value at all times, and hence, the anomaly level is also constant. The respective anomaly levels of the anomalous data were 77.2 for the Arnoldi method, 74.7 for the Shift-invert Arnoldi method, and −4.5 for the LSTM.

The Arnoldi method and the Shift-invert Arnoldi method can distinguish the normal data from the anomalous data more clearly than the existing method. Referring to FIG. 8, even the normal data exhibits dispersion somewhat from the training data at times around 60 to 80. On the other hand, around times 0 to 10, there is no dispersion from the training data. In the Arnoldi method and the Shift-invert Arnoldi method, although the anomaly levels are high around times 60 to 80, the anomaly levels around times 0 to 10 are low, and hence, it can be understood that the appropriate anomaly levels can be calculated by taking the randomness into account.

### SUMMARY EFFECTS OF EMBODIMENTS

As described above, according to the techniques described in the present embodiment, by approximating a Perron-Frobenius operator on a reproducing kernel Hilbert space, predictions can be generated in which the randomness of time-series data is captured. In this way, anomaly detection that takes into account the randomness of the data can be achieved.

More specifically, by considering a space called RKHS, the concept of inner product can be used. Also, a Krylov subspace can be generated by approximation from a finite number of data items. In this way, approximation of a Perron-Frobenius operator can be executed by the Krylov subspace method.

By using the Shift-invert Arnoldi method, a Perron-Frobenius operator that does not have the property of being bounded can be approximated. By using the approximate operator to generate predictions, an anomaly level can be defined by the discrepancy between the predictions and the observations, to execute anomaly detection.

Information on the randomness is incorporated into the Perron-Frobenius operator; therefore, anomaly detection taking the randomness into account can be achieved. The magnitude of the prediction in an RKHS represents the dispersion level of the prediction; therefore, it can be used for setting a threshold value of the anomaly level to determine whether it is anomalous.

The present specification describes at least the following matters related to an anomaly detection apparatus, an anomaly detection method, and a program:

### (Matter 1)

An anomaly detection apparatus comprising:
an approximation unit configured to generate, based on observed data, an approximation of a Perron-Frobenius operator on a reproducing kernel Hilbert space (RKHS) that represents a mathematical model to generate the observed data; and
a detection unit configured to use the approximation of the Perron-Frobenius operator and an observed data item at time t, to predict a data item at time t+1, and based on a discrepancy between the predicted data item and an observed data item at time t+1, to determine whether the observed data item at time t+1 is anomalous.

### (Matter 2)

The anomaly detection apparatus as described in Matter 1, wherein the approximation unit uses the approximation of the Perron-Frobenius operator to calculate an index of a dispersion level of predictions with respect observed data items, and

wherein the detection unit uses a threshold value according to the index of the dispersion level, to determine whether the observed data item is anomalous.

### (Matter 3)

The anomaly detection apparatus as described in Matter 1, wherein the index of the dispersion level is a magnitude of the predictions in the RKHS obtained by using the approximation of the Perron-Frobenius operator.

### (Matter 4)

The anomaly detection apparatus as described in any one of Matters 1 to 3, wherein the approximation unit partitions the observed data into S sets of data sets, to generate the approximation of the Perron-Frobenius operator restricted to an S-dimensional space by an orthogonalization operation from the S sets of the data sets.

### (Matter 5)

The anomaly detection apparatus as described in Matter 4, wherein the approximation unit generates the approximation of the Perron-Frobenius operator by a Shift-invert Arnoldi method.

### (Matter 6)

An anomaly detection method executed by an anomaly detection apparatus, the method comprising:
generating, based on observed data, an approximation of a Perron-Frobenius operator on a reproducing kernel Hilbert space (RKHS) that represents a mathematical model to generate the observed data; and
using the approximation of the Perron-Frobenius operator and an observed data item at time t, to predict a data item at time t+1, and based on a discrepancy between the predicted data item and an observed data item at time t+1, to determine whether the observed data item at time t+1 is anomalous.

### (Matter 7)

A program for causing a computer to function as respective units of the anomaly detection apparatus as described in any one of

Matters 1 to 5.

As above, the embodiments of the present invention have been described; note that the present invention is not limited to such specific embodiments, and various modifications and changes may be made within the scope of the subject matters of the present invention described in the claims.

The present patent application claims the priority of Japanese Patent Application No. 2019-154065 filed on Aug. 26, 2019, and the entire contents of Japanese Patent Application No. 2019-154065 are incorporated herein by reference.

### DESCRIPTION OF REFERENCE CODES

100 time-series data anomaly detection apparatus

110 observed data obtaining unit

120 approximation unit

121 Perron-Frobenius operator approximation unit

122 dispersion level calculating unit

130 detection unit

1000 drive device

1001 recording medium

1002 auxiliary storage device

1003 memory device

1004 CPU

1005 interface device

1006 display device

1007 input device

1. An anomaly detection apparatus comprising:
a memory; and
a processor configured to execute
generating, based on observed data, an approximation of a Perron-Frobenius operator on a reproducing kernel Hilbert space (RKHS) that represents a mathematical model to generate the observed data; and
using the approximation of the Perron-Frobenius operator and an observed data item at time t, to predict a data item at time t+1, and based on a discrepancy between the predicted data item and an observed data item at time t+1, to determine whether the observed data item at time t+1 is anomalous.

2. The anomaly detection apparatus as claimed in claim 1, wherein the generating uses the approximation of the Perron-Frobenius operator to calculate an index of a dispersion level of predictions with respect observed data items, and
wherein the using uses a threshold value according to the index of the dispersion level, to determine whether the observed data item is anomalous.

3. The anomaly detection apparatus as claimed in claim 2, wherein the index of the dispersion level is a magnitude of the predictions in the RKHS obtained by using the approximation of the Perron-Frobenius operator.

4. The anomaly detection apparatus as claimed in claim 1, wherein the generating partitions the observed data into S sets of data sets, to generate the approximation of the Perron-Frobenius operator restricted to an S-dimensional space by an orthogonalization operation from the S sets of the data sets.

5. The anomaly detection apparatus as claimed in claim 4, wherein the generating generates the approximation of the Perron-Frobenius operator by a Shift-invert Arnoldi method.

6. An anomaly detection method executed by an anomaly detection apparatus including a memory and a processor, the method comprising:
generating, based on observed data, an approximation of a Perron-Frobenius operator on a reproducing kernel Hilbert space (RKHS) that represents a mathematical model to generate the observed data; and
using the approximation of the Perron-Frobenius operator and an observed data item at time t, to predict a data item at time t+1, and based on a discrepancy between the predicted data item and an observed data item at time t+1, to determine whether the observed data item at time t+1 is anomalous.

7. A non-transitory computer-readable recording medium having computer-readable instructions stored thereon, which when executed, cause a computer including a memory and a processor to execute respective operations of the anomaly detection apparatus as claimed in claim 1.
